(19) United States
(12) Patent Application Publication
(10) Pub. No.: US 2002/0133554 A1
(43) Pub. Date: Sep. 19, 2002

(54) E-mail answering agent

(76) Inventors: Daniel Checkoway, Newport Beach, CA (US); Neal Checkoway, San Francisco, CA (US)

Correspondence Address: GLENN PATENT GROUP, 3475 EDISON WAY, SUITE L, MENLO PARK, CA, 94025, US

(21) Appl. No.: 09/749,323

(22) Filed: Dec. 27, 2000

Related U.S. Application Data
(60) Provisional application No. 60/207,895, filed on May 25, 2000.
(60) Provisional application No. 60/211,345, filed on Jun. 13, 2000.

(51) Int. Cl. G06F 15/16

(52) U.S. Cl. 709/206

(57) ABSTRACT

The present invention is answering agent accessible at an e-mail destination address. The answering agent waits for e-mail messages to be delivered that have a “To:” header and a “Subject:” header. The “To:” header is filled-in by a user and has two halves, a topic half and a domain name half in the form of “topic@domain-name”. The answering agent logically resides at the corresponding domain-name address on a network, e.g., the Internet. It extracts the source addresses of e-mail messages it receives so that it knows where to return answers and where a database of preferences might be indexed locally. The topic refers to an area of information that the user has a question about. The “Subject:” header is filled-in by the user with a qualifier that helps narrow down the breadth of the user's inquiry. A finite set of topical areas are accessible to the user through the answering agent. A database and the Internet itself are data-mined for current information and the locations of information that could be used to answer users' questions. The answering agent, in effect, converts e-mail format queries for information into standard browser websearches and collects the answers to the questions. The questions can be anticipated and the answers placed in a cache, or the questions can be researched automatically in real-time.

### CROSS REFERENCE TO RELATED APPLICATION

This application claims priority to U.S. patent application Ser. No. 60/207,895, filed on May 25, 2000, (Attorney Docket No. IVOL0002PR) and U.S. patent application Ser. No. 60/211,345, filed on Jun. 13, 2000, (Attorney Docket No. IVOL0002PR2), of which the entirety of both applications are hereby incorporated by reference.

### BACKGROUND OF THE INVENTION

1. Technical Field

The present invention relates to e-mail and Internet information systems, and more specifically to services that permit ordinary e-mail clients already installed on a consumer appliance to be used as the only necessary interface for making reference information queries.

2. Description of the Prior Art

Finding information is an art. Professionals are better at finding what they need than are first timers. Some sources are better than others. A good source today can often be eclipsed by another tomorrow, etc. Using the Internet to gather information is basically no different than more traditional sources.

The vast majority of Internet users have simple information needs, and most have no reason to spend the time necessary to become proficient researchers. Many people just need to know where the closest ATM-machine is, where is area code 765, what's playing at the local movies, what is the 800-number for Nordstroms, etc. These, and much more can be found on the Internet, but it takes some time and skill to find the information, and some devotion to stay on top of website changes.

E-mail clients are now appearing in cellular phones, Palm devices, and even pagers. Such small appliances don't offer much support for a keyboard or a browser. So being able to find useful information on demand through a small portable device has been very limited in prior art systems.

A simple, consistent, familiar, and reliable system is needed that allows users to make information requests and receive relevant and useful answers. Such, regardless of the Internet medium chosen. Such further implies that an information center is needed on the Internet that can respond to many different queries that arrive on different kinds of communications mediums.

### SUMMARY OF THE INVENTION

Briefly, one embodiment of the present invention comprises an answering agent accessible at an e-mail destination address. The answering agent waits for e-mail messages to be delivered that have a “To:” header and a “Subject:” header. The “To:” header is filled-in by a user and has two halves, a topic half and a domain name half in the form of “topic@domain-name”. The answering agent logically resides at the corresponding domain-name address on a network, e.g., the Internet. It extracts the source addresses of e-mail messages it receives so that it knows where to return answers and where a database of preferences might be indexed locally. The topic refers to an area of information that the user has a question about. The “Subject:” header is filled-in by the user with a qualifier that helps narrow down the breadth of the user's inquiry. A finite set of topical areas are accessible to the user through the answering agent. A database and the Internet itself are data-mined for current information and the locations of information that could be used to answer users' questions. The answering agent, in effect, converts e-mail format queries for information into standard web-based and database-based searches and collects the answers to the questions. The questions can be anticipated and the answers placed in a cache, or the questions can be researched automatically in real-time.

### BRIEF DESCRIPTION OF THE DRAWINGS

FIG. 1 is a functional block diagram of an e-mail answering agent embodiment of the present invention;

FIG. 2 is a functional block diagram of an e-mail, HTTP, and WAP answering agent embodiment of the present invention;

FIGS. 3A-3C are flowcharts describing a composer embodiment of the present invention as can be used in FIGS. 1 and 2;

FIG. 4 is a flowchart describing a scheduler embodiment of the present invention as can be used in FIGS. 1 and 2;

FIGS. 5A-5E are flowcharts describing a receiver embodiment of the present invention as can be used in FIGS. 1 and 2;

FIGS. 6A and 6B are flowcharts that represent a topic server embodiment of the present invention as can be used in FIGS. 1 and 2; and

FIG. 7 is a diagram representing a way to organize database embodiments of the present invention.

### DETAILED DESCRIPTION OF THE INVENTION

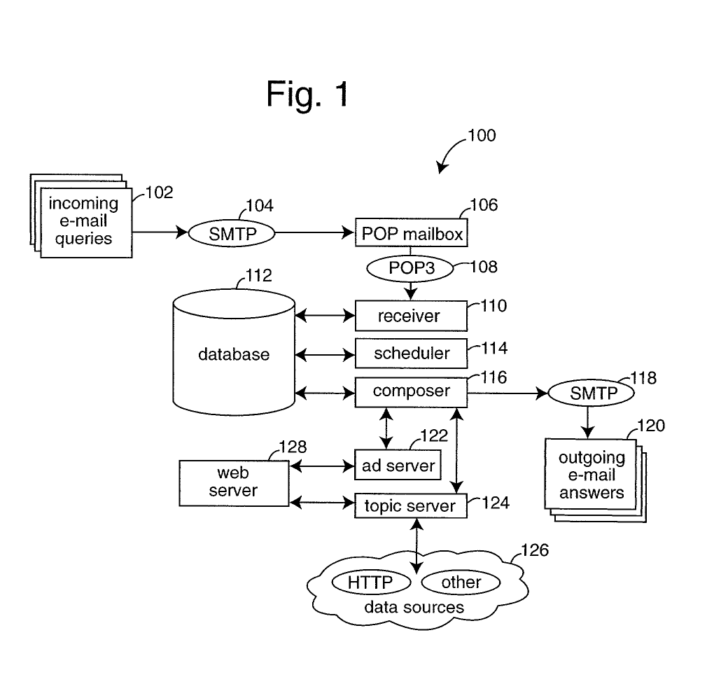

FIG. 1 represents an e-mail answering agent embodiment of the present invention, and is referred to herein by the general reference numeral 100. The answering agent 100 comprises a system for answering informational queries included in an incoming e-mail message 102. A simple mail transfer protocol (SMTP) network 104 is used to deliver these to a post-office protocol (POP) mailbox 106. From there, a receiver 110 monitors the (POP) mailbox through use of POP3 system 108. The key information is parsed and saved in a database 112 for processing. The receiver determines if the response should be plain text or can be HTML, depending on the e-mail application detected. A scheduler 114 continuously queues new requests in the database for pre-created, scheduled queries in parallel with ad-hoc queries coming from receiver. A composer 116 polls the queue in the database for pending requests. The composer makes requests through an analyzer/call router, which passes the request to a topic server 124. The topic server returns the answer. The composer formulates the answer as an e-mail message that is sent out on an SMTP system 118. A discrete e-mail message 120 with a responsive answer in the message body is sent back to the corresponding user.

Each answer can have an advertisement included by an ad server 122. In a business model embodiment of the present invention, advertisers pay a fee to a service provider to deliver ads to the users along with the answers to the queries. The answers themselves are obtained from the Web or databases by a topic server 124. In one embodiment, the Web is used as a real-time reference library of facts. A group of data sources 126 includes HTML and other kinds of documents on the Internet and in local databases. A webserver 128 is used to serve HTTP queries coming in via the Web.

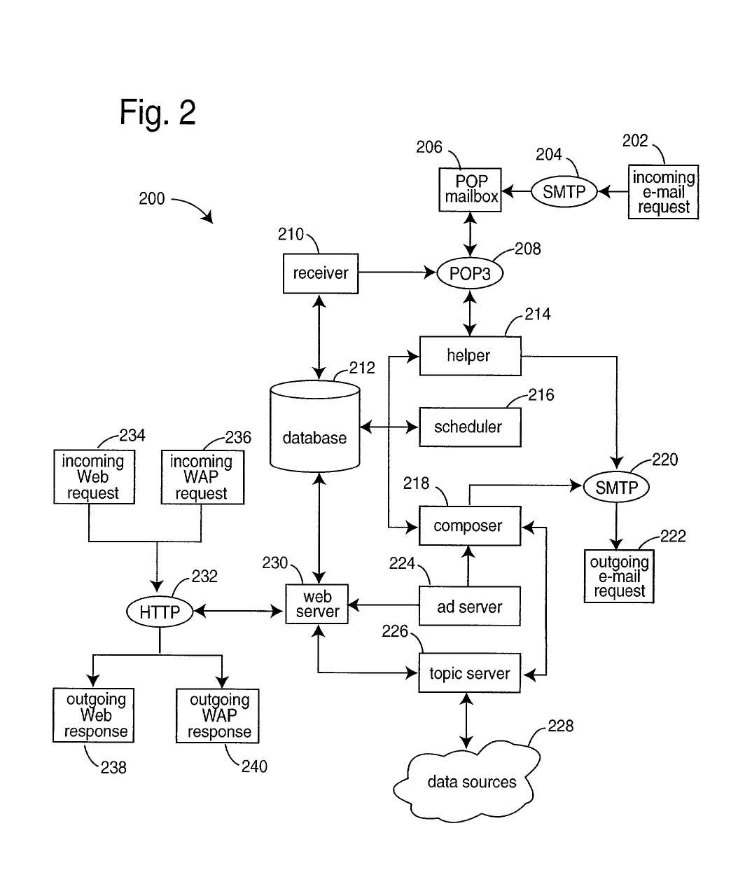

FIG. 2 represents a second e-mail answering agent embodiment of the present invention, and is referred to herein by the general reference numeral 200. The answering agent 200 can answer queries from SMTP e-mail, HTTP Web, and wireless access protocol (WAP). An incoming e-mail request 202 is carried by an SMTP system 204 to a POP-mailbox 206. A receiver 210 is connected to a POP3 server 208. A database 212 holds queries in a queue waiting for service. A helper 214 provides automated help responses to the user. A scheduler 216 inserts jobs that have been scheduled to be processed into the database queue for work by a composer 218. An SMTP server 220 handles outgoing traffic in the form of outgoing e-mail messages 222. An ad server 224 adds commercial paid advertisements to the outgoing answers and responses in a business model embodiment. A plurality of topic servers 226 are each specialized to research particular topics from a variety of data sources 228. A webserver 230 allows an Internet presence that can receive and respond to HTTP requests 232. Incoming jobs can be received from a web request 234 and also a WAP request 236. The webserver is connected to an analyzer and topic server like the composer, and sends answers to questions received from the Web and WAP via an outgoing Web response 238 and a WAP response 240.

The way a topic server 226 derives information varies from topic to topic, and is typically a six-step process. A first step dispatches requests to one of several built-in topic “modules” each appointed to handle one discrete topic, e.g., flight status, airfare, area code, movies, dictionary, etc. A second step parses and validates the query parameters. Each particular topic module knows exactly what kind of input it needs. In the case of flight status, an airline and a flight number are expected. In the case of travel directions, a starting and an ending address are necessary. These parameters are dissected using complex, flexible interpretations. For example, the entry of a physical address has seemingly infinite variations, all of which the system 100 and 200 must be able to interpret successfully. A third step starts with a webpage or other given data source and the parameters. It constructs a URL and the posted variables.

For example, once a physical address has been parsed from the query parameters, variables such as “addr=836+Green+Street&city=San+Francisco&state=CA” may be appended to a standard URL. A fourth step fetches/posts to the URL and reads a resulting HTML page, e.g., over a standard HTTP connection with the data source's web site. A step five crops the resulting “raw” HTML to the bare essential information. Typically, there is only a very small section of the resulting web page that is useful to the user. The rest consists of navigation links, advertising, and general aesthetic layout. Only the raw results are needed, so the rest is stripped off.

A sixth and last step parses the HTML and reformats the results depending on the requested output format. Such is a complex process that must usually be custom built for each discrete topic that uses a web site as its data source. Not every HTML page looks the same, so each topic module must “know” the format of its respective data source. When the response comes back, the topic module must interpret the HTML, like a browser, to present it to the user in a meaningful way. For example, if the requested output format is text, and the HTML results contains a table of information, the table tags must be parsed so that the rows and columns of information can be logically redisplayed in plain text. There is a generalized method for doing this that is shared among many topic modules, although no two are purely identical. For example, the HTML “</TD>” tag signifies the end of a column, which aids in separating informational tokens. The “</TR>” tag signifies the end of a row in a table, and indicates a logical place to put a line break.

In an example of the operation of one embodiment of the present invention, a user wants to know what time a particular airline flight is supposed to land. The user sends an e-mail message to “flightstatus@halibot.com” and includes the airline and flight number in the subject field, for example,

From: user@somewhere.net
To: flightstatus@halibot.com
Subject: United 2507

When the message arrives in POP mailbox 206 on halibot.com, the receiver 210 detects the new request. It parses out the topic based on the address to which the message was sent and the request parameters from the subject. It also determines the most appropriate output format based on the e-mail application used to compose and send the message. It then queues-up a new request in the database 212. The composer 218 constantly polls the database 212 to detect any queued requests. It connects to the topic server 226 and conveys the topic name, parameters, and output format. The composer 218 takes any results returned from the topic server 226 and sends a message back to the user, for example,

From: flightstatus@halibot.com
To: user@somewhere.net
Subject: Re: United 2507
Flight information last updated less than 1 minute ago.
United Airlines 2507
Departing San Francisco Intl, CA
5:38pm
In Flight
329 mi SW of Chicago, IL
33000′
475 mph
B744
Arriving Newark Intl, NJ
1:11am

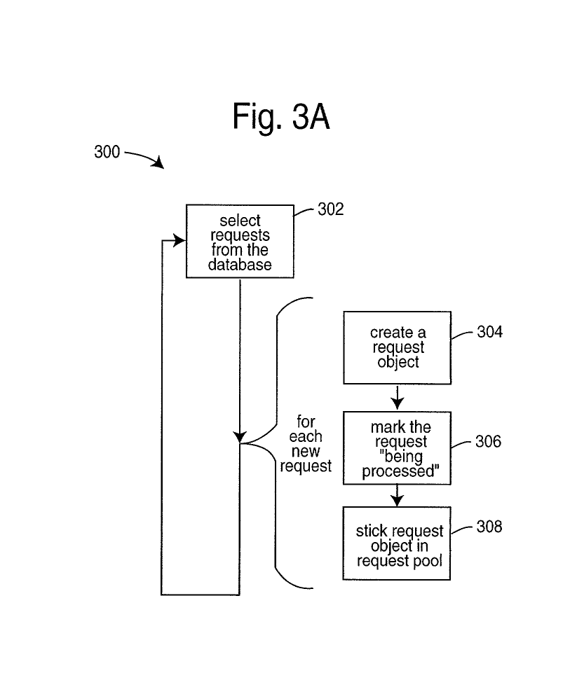

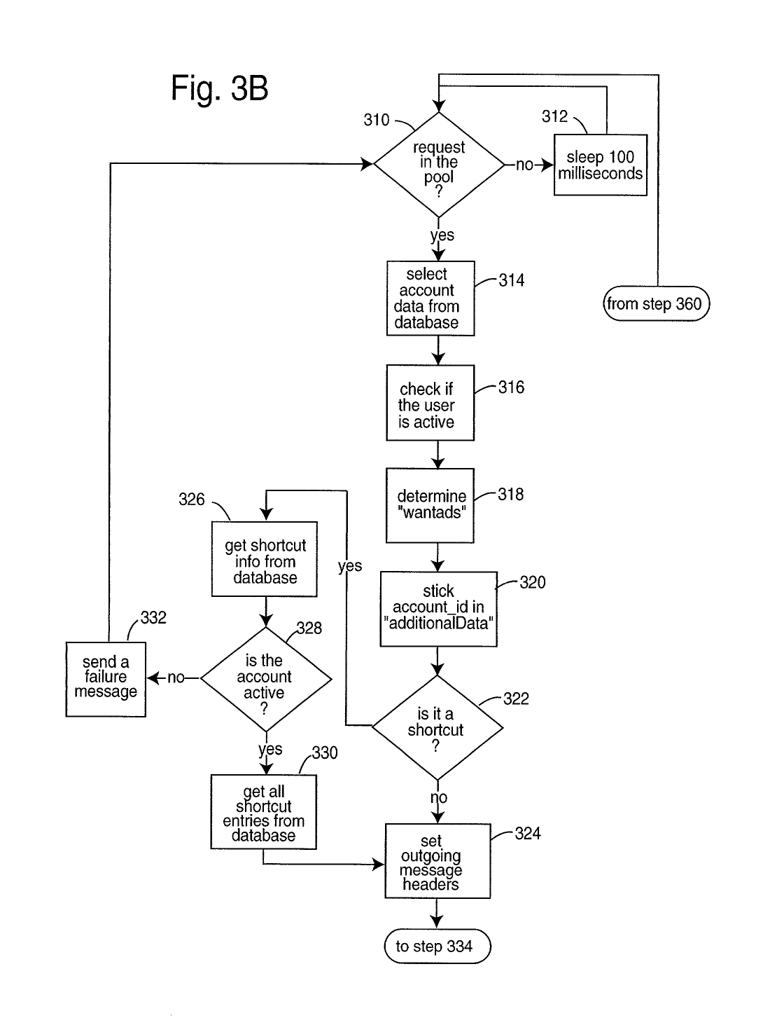

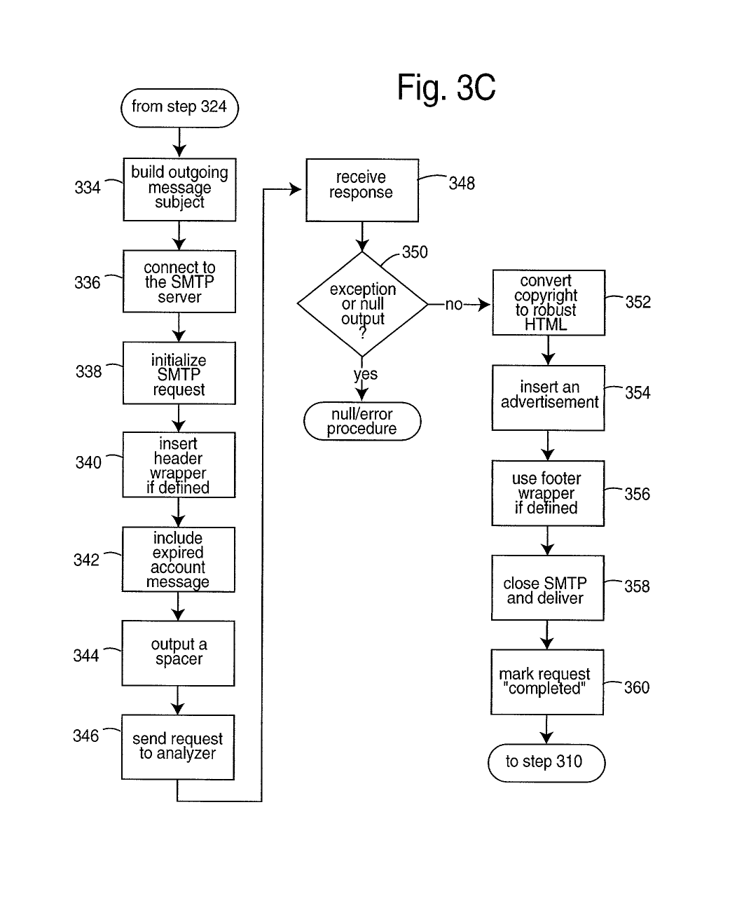

FIG. 3A represents a composer main loop 300. A process 302 selects queued requests from the database. In each iteration of the main loop, the composer 116 and 218 examines a “mail_queue” database table to see if there are any requests that need to be processed. A “fresh” request is identified when a “being_processed_by” column is null, a “began_processing” column is null, and a “completed” column is null. All requests that conform to these criteria are selected by an SQL statement. Such sorts first by priority, and then by the time at which the request was created. The highest priority is given to the oldest requests. A typical SQL statement that can be used is in the following table.

select * from mail_queue where being_processed_by is
null and began_processing is null and completed is null order by
priority, created

In a step 304, a request object is created if one or more requests that need to be processed are detected in the queue. A “request object” is a C++ class object created for each and is placed in a “request pool”. Such object contains the topic and parameters, the sender's e-mail address, the system's e-mail address, etc. The composer process threads continuously check the pool for pending request objects. Each object's member variables are populated with data from a corresponding row from a “mail_queue” table with columns for ID, priority, sender_e-mail, format, our_e-mail, addl_recipients, shortcut_id, genre_id (if defined), and parameters (if genre_id is defined).

A step 306 marks the request as “being processed” to distinguish requests that are being processed from those that are either completed or new and unprocessed. For example, attributes in the “mail_queue” database table are used as flags. A “being_processed_by” column, e.g., is used to log the process that took on the respective request. Such process is preferably identified by its process ID and machine on which it's running. The “began_processing” column is set to the date/time when the request was first acknowledged by the composer. Another SQL statement can be used to mark a request as being processed. For example in the next table, the process ID is 40857, the hostname of the machine on which the composer is running is “chonburi”, and the request ID is 291,

update mail_queue set being_processed by=‘composer.chonburi.40857’,
began_processing=now( ) where id=291

A step 308 puts each such request object in a global “request pool” that is shared by the main the composer thread and all processing threads. The request pool is preferably protected and synchronized by mutex locking, and is used by the main thread when it puts new requests into the pool. Processor threads remove the requests from the pool as they appear instead of doing a database select from the “mail_queue” table. They simply fetch pending requests, already created and prioritized, from the request pool. So, as the main the composer thread finds new requests, creates request objects, and marks them being processed, it adds these request objects to the pool and continues iterating.

FIGS. 3B and 3C represent a composer processor thread loop. A step 310 looks to see if there is a request in the pool. Each composer processor thread constantly monitors the request pool for new, pending request objects. Lock contention and synchronization areas are handled by mutex locking to avoid two threads getting access to the same request object at the same time. If the processor thread finds a request object in the pool, it removes it from the pool and processes it. If there are no pending requests, the processor thread sleeps, e.g., for one hundred milliseconds, and checks again in a step 312. A step 314 selects the relevant account data from the database. The request may have come from a registered user or a non-registered user. If the user is registered, step 316 looks to make sure the account is still active, in case the user is trying to invoke a shortcut. Such method can be restricted in a business model embodiment to active, paying users. An SQL statement like that in the following table can be used to fetch any related account information and preferences.

select account.id, if(now( ) < service_end, ‘Y’, ‘N’) as is_active,
email.is_primary, preferences.want_ads from email, account, preferences
where upper(email.email)=upper(‘dan@checkoway.com’) and
account.id=email.account_id and
preferences.account_id=email.account_id

If a row is returned from the database query, and if the “is_active” column returned is ‘Y’, then the user is verified as an active subscriber or registered user. A step 318 determines the “wantAds” to be inserted in the answer. By default, an advertisement is served with the response message. If the database query returns a “want_ads” column with ‘N’, then no advertisement is included if the users account has not expired. A step 320 puts an account_id in an “additionalData” hash. If the query returned a row, the registered user's “account_id” is stored in the “additionalData” hash. Such hash generally contains any extraneous data that would otherwise be unrelated to the request being made. Providing the account_id, however, enables the topic processor to be able to associate user-specific information with the request by identifying which user is making the request. A step 322 30 checks to see if the request is a shortcut. If the request object's “shortcut_id” is set, the genre_id and parameters in the request object can be ignored, since the shortcut's queries are loaded in a later step. If not, a step 324 sets the outgoing message headers. A step 326 gets the shortcut name and description from the database. A “shortcut_id” is found in the request object.

In the case of a “normal” query, when the response message is constructed the parameters entered are used to construct the subject of the outgoing message. For example, if the parameters are “Newport Beach, Calif.”, the subject would be “Re: Newport Beach, Calif.”. When a shortcut is invoked, the subject should be the shortcut's description, as specified by the user when the shortcut is first created. If a description has not been defined, the name of the shortcut is used. An example SQL statement to load the shortcut's name and description could be constructed like, “select name, description from shortcut where id=857”. A step 328 checks to see if the account is active. A step 330 gets all shortcut entries from the database which can have one or more “entries” for a topic/qualifier pair. A shortcut with more than one entry is a “composite” shortcut. All the entries in a shortcut can be fetched with an SQL statement, e.g., “select genre_id, parameters from shortcut_entry where shortcut_id=857 order by id”. The “is_active” value can be used to examine the active status of the account. If the account is inactive and a shortcut is being invoked, the request is rejected. In a business model embodiment of the present invention, the shortcut queries are only available to active users who are paid subscribers. A step 332 sends back a failure message instead of running the query. The resulting rows are alternatively read and each topic/qualifier pair is stored in a list. A basic error check is made to verify the list of pairs is not empty. Step 324 sets the outgoing message headers, based on the response format requested by the user. The outgoing message headers indicate the type of content being delivered. If the requested format is HTML, the headers are “Mime-Version: 1.0” and “Content-Type: text/html”. Otherwise, plain text results are indicated by “content-Type: text/plain”. To simplify tracking, embodiments preferably add a header to indicate the output format that the user originally requested, e.g., “X-Halibot-Format: html”.

Referring now to FIG. 3C, the process continues with a step 334 that builds the subject for an outgoing message. If a shortcut is being invoked, its description is used. If such description is unavailable, the shortcut name is used. Otherwise, the parameters are appended with “Re: ”, as in “Re: Newport Beach, Calif.”A step 336 connects to the SMTP server. A stream socket is opened on the client machine, and a connection is made to the mail server machine, e.g., on port 25. If the connection is made successfully, the client checks for a server response code, e.g., “220”. A step 338 initializes an SMTP request. Subsequent client/server transactions typically expect a response code from the server after each command of “250”.

A client uses a “HELO” command to identify itself to a server and sends a “RSET” command to ensure that a “session state” is clear. The client then sends a “MAIL FROM:” command to initiate a new message and declare a sender's return path. The “RCPT TO:” command is used to designate the recipients of the message. The “DATA” command is used to initiate the message content (a response code of “354” is expected). The client then sends the outgoing message headers, followed by one blank line (CR-NL) to signal the start of the message body. Here is an example of this transaction. Client commands are preceded with ‘*’ to differentiate. An example follows in the table.

220 localhost.localdomain ESMTP Sendmail 8.9.3/8.9.3; Mon, 8 May
2000 11:45:35 -0700

| | |
|---|---|
| * | HELO server.halibot.com |

250 localhost.localdomain Hello localhost.localdomain [127.0.0.1], pleased to meet
you

| | |
|---|---|
| * | RSET |

250 Reset state

| | |
|---|---|
| * | MAIL FROM: weather@halibot.com |

250 weather@halibot.com... Sender ok

| | |
|---|---|
| * | RCPT TO: dan@checkoway.com |

250 dan@checkoway.com... Recipient ok

| | |
|---|---|
| * | RCPT TO: neal@ivolio.com |

250 neal@ivolio.com... Recipient ok

| | |
|---|---|
| * | RCPT TO: jon@thispc.com |

250 jon@thispc.com... Recipient ok

| | |
|---|---|
| * | DATA |

354 Enter mail, end with “.” on a line by itself

| | |
|---|---|
| * | To: dan@checkoway.com |
| * | Cc: neal@ivolio.com, jon@thispc.com |
| * | From: weather@halibot.com |
| * | Reply-To: weather@halibot.com |
| * | Subject: Re: Newport Beach, CA |
| * | Date: Mon, 8 May 2000 14:37:29 -0700 |
| * | Mime-Version: 1.0 |
| * | Content-Type: text/plain |
| * | X-Halibot-Format: text |
| * | |

A step 340 looks to see if a header wrapper was defined for this format. The composer can automatically embed a standard header and/or footer in every response message, and both text and HTML headers and footers can be specified in the configuration file. These are called “wrappers”, since the header and footer collectively “wrap” the content of the response. If a header wrapper was specified in the configuration file for the particular format being requested, this is appended to the response message before any other content is appended. A step 342 includes any expired account message. If the user account has expired, a message is inserted into the response about the expiration. Such message is customized and specified in the composer configuration file. A step 344 outputs a spacer. A spacer is inserted between each section of topic output in the response message for a composite shortcut. In the case of a plain text response, a series of hyphens are used, and in the case of HTML, a horizontal rule is used (e.g., <HR SIZE=6 COLOR=“#000000”>). A step 346 sends a request to an analyzer, or centralized topic server “call router”. The composer can simply post its request to this service, and the analyzer handles the rest, simply acting as a black box to produce the response. The communication between the composer and analyzer is HTTP. The composer posts to analyzer, typically a Java servlet, including the following parameters as form variables,

account_id: the ID of the user, if one has been identified
topic_name: the name of the topic to query
shortcut_id: if the request is a shortcut, its ID
email: the e-mail address of the user
subject: the query itself
body: the content of the message used to invoke this query
format: the response format desired, e.g., “raw”, “text”, “html”, or “wml”.

A step 348 receives a response. The analyzer routes the query and returns a response in the form of URL-encoded data. The composer receives the response via the HTTP connection and decodes the data into key/value pairs. The following keys may be provided in the response:

results: the formatted response to the query
error_msg: if an error occurred, this contains a descriptive message
about the problem
modified_subject: a potentially new, modified outgoing subject for
the e-mail response
was_action: specified and set to ‘Y’ if the query performed an
action/transaction, e.g., the body of the incoming message contained
an action, such as a checked off item, or a quantity entered next to an item
to be purchased
signature: a string identifying the topic server that provided the underlying
response

A step 350 checks to see if there was an exception or output null. If either the “error_msg” is non-null, or the output is null, the “handleNullOrErrorResponse” procedure is called to inform the user of this condition. It may be due to an improper invocation by the user. A step 352 converts the copyright to robust HTML. If the requested output format is HTML, the copyright is also converted to “robust” HTML by turning any links in the copyright to “clickable” links. For example, if the copyright is,

Information provided by Yahoo! Inc. http://www.yahoo.com
Copyright © 2000 Yahoo! Inc.

The converted copyright would be,

Information provided by Yahoo! Inc. <A
HREF=“http://www.yahoo.com”>http://www.yahoo.com</A>
Copyright © 2000 Yahoo! Inc.

A step 354 inserts an advertisement. If a “wantAds” variable is true, an advertisement is appended to the message. If the requested output format is HTML, a fully clickable banner ad image is inserted. Otherwise, a text-based advertisement is used. A step 356 checks to see if a footer wrapper is defined for the format. If there is a footer wrapper specified for the requested output format, it is appended to the outgoing message. A step 358 closes the SMTP connection and delivers the message. The client sends a single line containing only “.”, signifying the end of the message data. A “QUIT” command is then issued to close the SMTP connection. The sendmail server is responsible for delivering the fully constructed response message to the user. A step 360 marks the request object as “completed”, e.g., “update mail_queue set completed=now( ) where id=291.” Program control returns to step 310.

A handleNullOrErrorResponse procedure is typically called whenever a topic query returns either an error or null output results. It is used to notify the user of potential causes for the problem, e.g., misusing the topic, as well as providing an automated help response. If there was an exception, and it has a non-zero error code, an error message will be appended to the response message, e.g., “specified an invalid qualifier”. If the output from the topic server was null, and the exception error code is zero, a message is added saying that no data was available for the user's request. When the user either encounters an error or gets no response for a particular query, the user is preferably provided with as much help as possible to prevent repeated problems in future queries. The system keeps track of how many times each user has encountered an error when using a particular topic. The first time an error occurs for a given user, they are provided with a topic description, a qualifier format, and an example qualifier. These get loaded from the database using an SQL statement, e.g., “select * from genre where lower(name)=lower(‘directions’) and is_active=‘Y’”.

If such query doesn't return a row, the topic is most likely being invoked by an alias. Another SQL statement is to resolve it and fetch the parameters mentioned, e.g., “select genre.* from genre, genre_alias where lower(genre_alias.alias)=lower(‘driving’) and genre.id=genre_alias.genre_id and genre.is_active=‘Y’”.

Each time a user misuses the system 100 and 200 or encounters problems while using a topic, a series of available “automated help messages” is rotated through that provides context-sensitive help. The general help is appended to the response message. The following table includes an example of what is displayed the first time a user encounters an error. Thereafter the message changes as the rotation through the automated help database progresses.

```
Sony, no data is available for that request, directions, “blah”.
Here's some general help on this topic in case you may have
forgotten how to use it properly.
Topic:
  directions@halibot.com
Description:
  Point-to-point driving directions
Subject Format:
  Origin-Destination
Example:
  Napa, CA-100 Jackson St, San Francisco
```

When the user requests HTML responses, more robust help can be provided, e.g., by appending an “extended_description” from the genre database table to the response message.

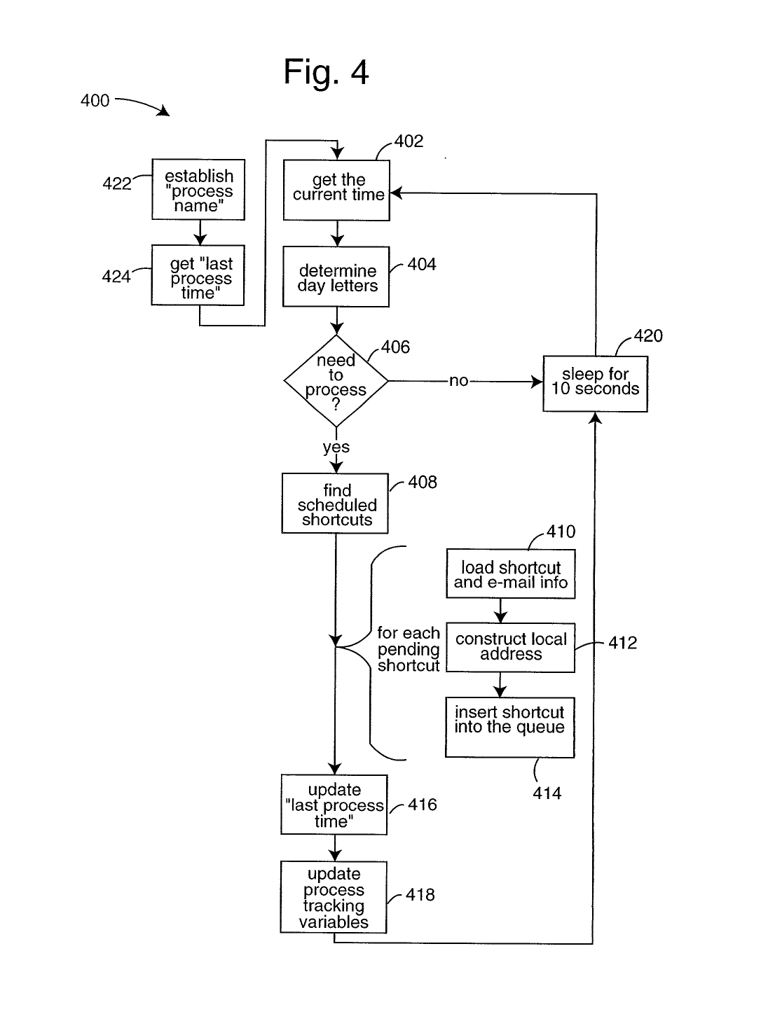

FIG. 4 represents a scheduler process 400. A step 422 establishes a process name, and a step 424 gets the last process time. A step 402 gets the current time to establish a current system time. A step 404 determines any character day letters for today, yesterday, tomorrow. For example, if the current day of the week is Wednesday, today would be ‘W’, yesterday is ‘T’ (Tuesday), and tomorrow is ‘H’ (Thursday). A step 406 checks to see if processing is necessary. If the last day of the week the scheduler 114 and 216 ran was yesterday, any remaining events that were scheduled to go out yesterday after the last time processing occurred are processed. If this is the case, a “last_time” variable is reset to zero to indicate that no processing was done “today”. A current time integer is built by multiplying the current hour by one hundred and adding the current minute, e.g., “1:05 pm” becomes “1305”. If today was the last weekday processing was done, and the last time when processing was done is equal to or after the current time, processing can be skipped. A step 408 finds any scheduled shortcuts that need handling. Three criteria determine whether a shortcut should be processed and delivered immediately. But something scheduled for “tomorrow” in another time zone might need to be delivered now, today in this time zone. If any one of the three criteria is true, a shortcut should be processed. The following SQL statement is an example,

select * from delivery_schedule where
(weekday=TODAY and
(time + zone_diff) > lastTime and
(time + zone_diff) <= currentTime)
or
(weekday=TOMORROW and
(2400 + time + zone_diff) > lastTime and
(2400 + time +zone_diff) <= currentTime)
or
(weekday=YESTERDAY and
(time + zone_diff − 2400) > lastTime and
(time + zone_diff − 2400) <= currentTime)

A step 410 loads the shortcut information, e-mail address, and format. For each of the shortcuts that need processing, information about the shortcut is loaded. The e-mail address to which the shortcut should be delivered and the preferred output format for that e-mail address are also loaded. A step 412 constructs a local e-mail address. The shortcut name is used to construct the address from which the shortcut should be delivered. For example, if the shortcut name is “mystocks”, the local e-mail address will be “mystocks@halibot.com”. A step 414 inserts the shortcut into the queue. In order for the composer to pick up the shortcut and immediately process and deliver it, it is inserted it into the “mail_queue” database table,

insert into mail_queue(id, created, priority,
sender_email, format, our_email,
shortcut_id) values(null, now( ), 1, ‘dan@checkoway.com’, ‘A’,
‘mystocks@halibot.com’, 2994)

A step 416 updates a “last process time”. Once all shortcuts that need to be processed have been scheduled, the “process time” table is updated to indicate the current time as the last time processed. Such is done with a simple SQL statement, for example, assuming processing began at 2:01 am on Monday,

update process_time set last_weekday=‘M’, last_time=201
where name=‘productionl’

A step 418 updates any process tracking variables to provide process tracking during the next iteration of the loop, e.g., the “last_weekday” and “last_time” variables are updated to indicate the latest round of processing. A step 420 puts the process to sleep for ten seconds.

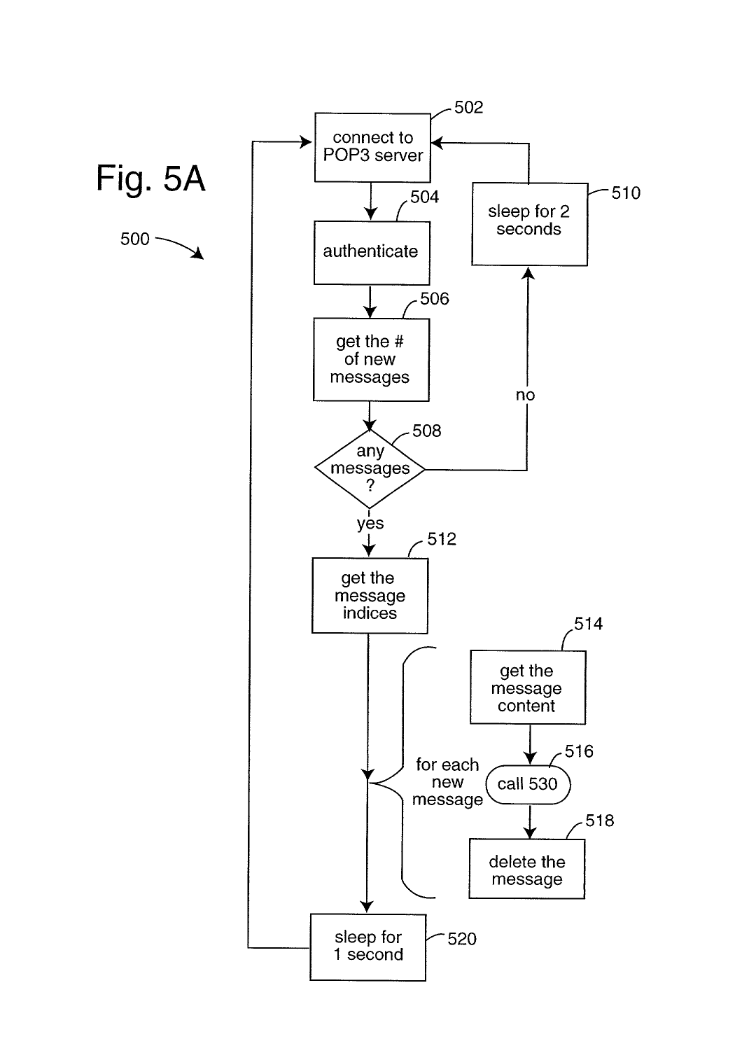

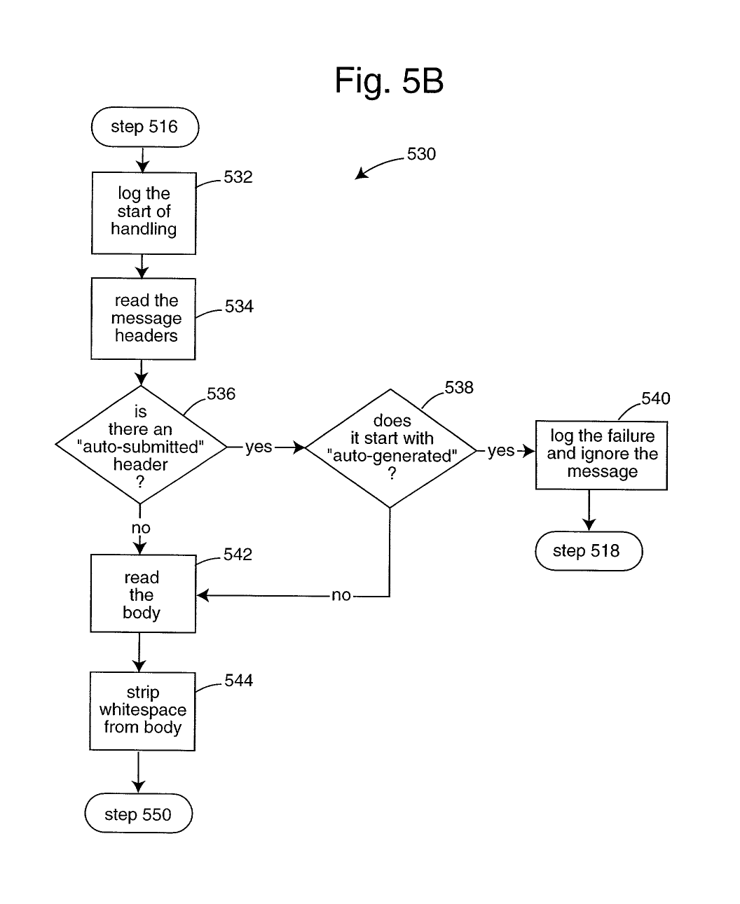

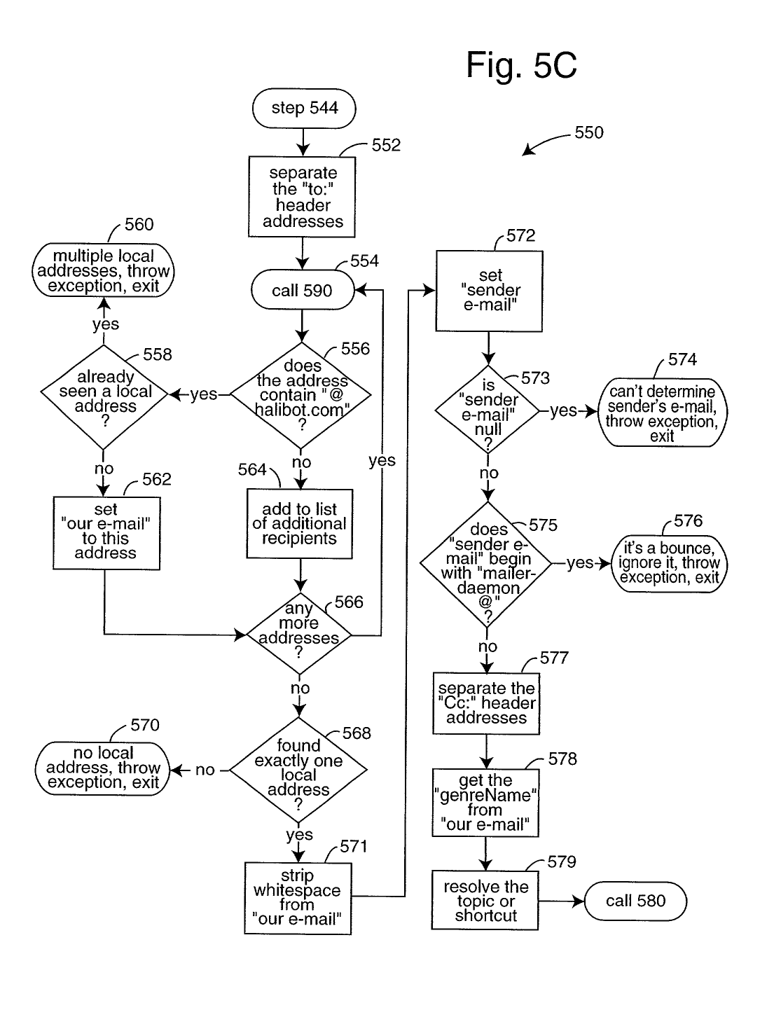

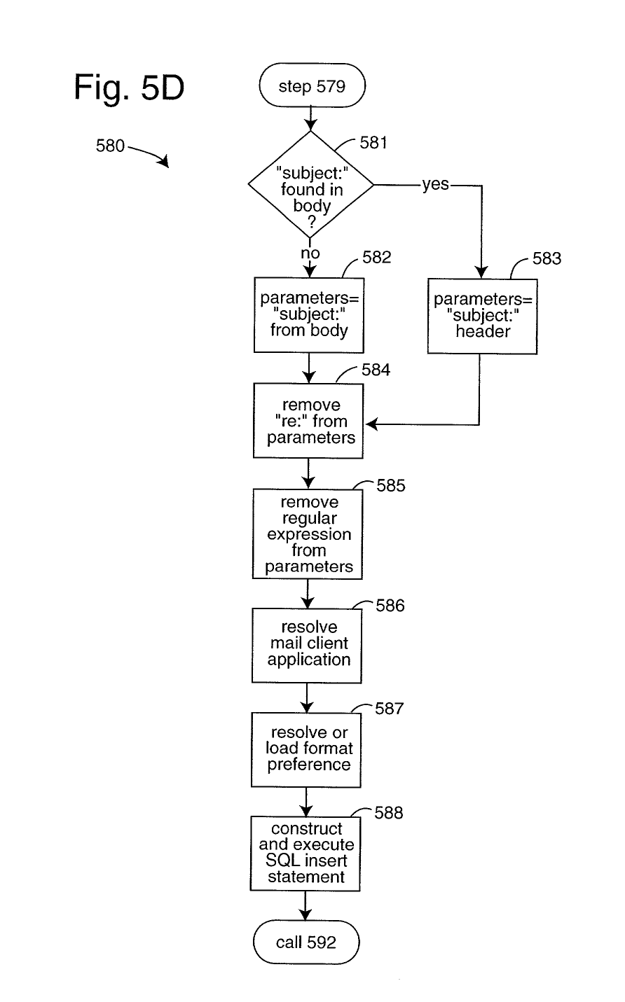

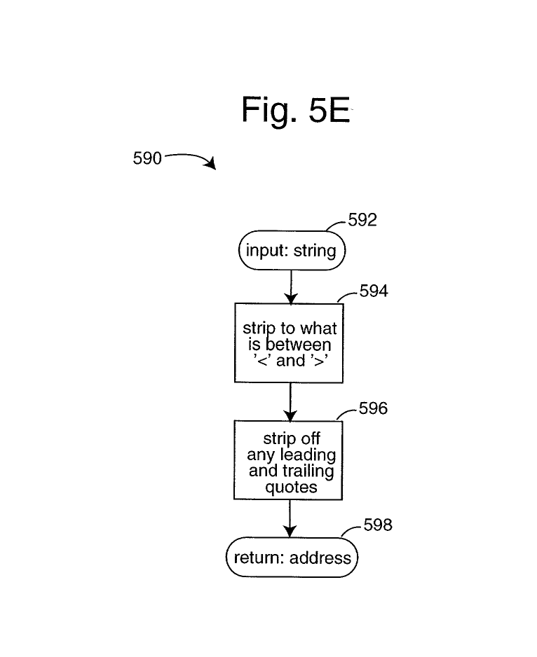

FIG. 5A represents a receiver process 500. A step 502 makes a connection to a POP3 server 108 and 208. A stream socket is opened on a client machine, and a connection is made to a server machine on port 110. If the connection is made successfully, the client makes sure a server's initial response line begins with “+OK” (as opposed to “−ERR”). A step 504 authenticates the connection. Assuming the POP mailbox in question is “halibot@halibot.com”, the client sends the command “USER halibot” followed by a CR (carriage return: 0×0D) and NL (newline: 0×0A) to the server. The server response is checked for “+OK” or “−ERR”. Then, assuming the mail account password is “mypassword”, the client sends the command “PASS mypassword” (followed by CR-NL) to the server, and again the response is checked for “+OK” or “−ERR”. A step 506 gets the number of new messages. The client sends a command “STAT” (followed by CR-NL) to the server, which responds with a status line (“+OK” or “−ERR”). If the status is “+OK”, a single line follows that contains two numerical values, the number of messages and the number of octets (total size, in number of bytes, of all messages in the mailbox). The response line is parsed for these two tokens, and the number of messages is established. A step 508 checks to see if there are any messages. If not, a branch back through a step 510 injects a two second sleep period. A step 512 gets all new message indices. Each message in a POP mailbox has a numerical index associated with it that reflects the message's relative position in the mailbox. An index of one means the first message. An index of “21” means the twenty-first message, and so on. This index is used to retrieve and/or delete the respective message from the server. To get the list of message indices, the client sends the command “LIST” (followed by CR-NL) to the server, which responds with a status line (“+OK” or “−ERR”). If the status is “+OK”, the client reads all message indices from the server, one line at a time. Each line from the server contains two numerical values, the message index and the number of bytes representing the size of that message. The client stores all message indices in a list.

For each new message, a step 514 gets the message content. For the given message index, e.g., “7”, the client sends the command “RETR 7” to the server, which responds with a status line (“+OK” or “−ERR”). If the status is “+OK”, the client then reads the message content from the server, one line at a time. As soon as a line containing only “.” is encountered, this signals the end of the message and the client stops reading. A step 516 calls program 530 illustrated in FIG. 5B. On return from program 530, a step 518 deletes the message. For the given message index, e.g., “7”, the client sends the command “DELE 7” to the server, which responds with a status line (“+OK” or “−ERR”). A step 520 injects a one second sleep so the loop does not iterate too quickly.

What follows is an example of a standard client/server POP3 transaction that proceeds after a connection has been established. Server responses are shown beginning with a “+”, and client commands are shown in lines beginning with a “*”.

+OK POP3 localhost.localdomain v7.64 server ready

| | |
|---|---|
| * | USER halibot |

+OK User name accepted, password please

| | |
|---|---|
| * | PASS myPassword |

+OK Mailbox open, 2 messages

| | |
|---|---|
| * | STAT |

+OK 2 1609

| | |
|---|---|
| * | LIST |

+OK Mailbox scan listing follows
1 890
2 719
.

| | |
|---|---|
| * | RETR 1 |

+OK 890 octets
Return-Path: <dan@checkoway.com>
Received: from bung.checkoway.com (bung.checkoway.com [10.0.0.2])

by www.checkoway.com (8.8.7/8.8.7) with SMTP ID QAA13186
for <directions@halibot.com>; Fri, 5 May 2000 16:21:26 -0700

Message-ID: <003901bfb6e8$b1c663a0$0200000a@checkoway.com>
From: “Dan Checkoway” <dan@checkoway.com>
To: <directions@halibot.com>
Subject: Newport Beach, CA - Venice, CA
Date: Fri, 5 May 2000 16:21:51 -0700
MIME-Version: 1.0
Content-Type: text/plain;

charset=“iso-8859-1”

Content-Transfer-Encoding: 7bit
X-Priority: 3
X-MSMail-Priority: Normal
X-Mailer: Microsoft Outlook Express 5.00.2919.6600
X-MimeOLE: Produced By Microsoft MimeOLE V5.00.2919.6600
Status: O
.

| | |
|---|---|
| * | DELE 1 |

+OK Message deleted

| | |
|---|---|
| * | RETR 2 |

+OK 719 octets
Return-Path: <dcheckoway@wyndtell.com>
Received: from nova.wyndtell.com (nova.wyndtell.com [63.81.201.78])
by ns1.wyndtell.com (8.9.3/8.9.3) with ESMTP ID QAA24941
for <weather@halibot.com>; Fri, 5 May 2000 16:22:41 -0700
From: dcheckoway@wyndtell.com (Dan Checkoway)
To: weather@halibot.com
Subject: Newport Beach, CA
Message-Id: <15360888.1553@wyndtell.com>
Date: Fri, 05 May 2000 16:22:41 -0700
Status:
.

| | |
|---|---|
| * | DELE 2 |

+OK Message deleted

| | |
|---|---|
| * | QUIT |

+OK Sayonara

FIG. 5B illustrates a handleNewMessage procedure 530. A step 532 logs the start of handling a new message. When this procedure is first called, information is inserted into a receiver log file that indicates that a new message is being processed. Information includes the current date/time, the message index and the content length of the message. A step 534 reads message headers from the message content. Typical e-mail messages have two structural components, message headers and message bodies. The message headers are parameter/value pairs that provide information such as who sent the message, to whom the message was sent, what application was used to generate the mail, and the subject of the message. The format of a single parameter/value pair is “Parameter: Value”, e.g., “To: weather@halibot.com”. Such usually takes a single line of text. If the value is long, the header can span multiple lines, e.g.:

Received: from nova.wyndtell.com (nova.wyndtell.com [63.81.201.78]),

by nsl.wyndtell.com (8.9.3/8.9.3) with ESMTP id
QAA24941, for <weather@halibot.com>; Fri, 5 May
2000 16:22:41-0700

The process of reading headers involves parsing the message content, one line at a time, building a dictionary of the parameters and their values. A blank line signifies the end of the headers and the beginning of the message body. A step 536 checks if it is an “auto-submitted” header. If yes, a step 538 checks to see if it starts with “auto-generated”. Whenever an attempt is made to send e-mail to a non-existing account, “sendmail” will preferably reply to the sender with a “bounce” message with the following header, “auto-submitted: auto-generated (failure)”. If an “auto-submitted:” header is encountered, and if the value of that header begins with “auto-generated”, the message received is a “bounce” message and not a legitimate, normal message. If this is the case the incoming message is ignored in a step 540. Control returns to step 518. A step 542 reads the body from the message content. The headers are separated from the message body by a blank line. A step 544 strips leading and trailing whitespace from the body. “Whitespace” is a common term that refers to any characters used for spacing, such as a space (0×20), tab (0×09), carriage return (0×0D), or newline (0×0A). Any of these characters that lie at the very beginning and end of the message body are removed to strip the body down to bare text.

FIG. 5C illustrates an insertIntoQueue procedure 550. A step 552 separates the “To:” header into a list of addresses. It is possible that multiple recipients may be specified in the “To:” header, as opposed to just one address. If multiple addresses are specified, they need to be parsed into a list of addresses. The delimiter used in the “To:” header is the comma character. A step 554 is a call procedure 590 (FIG. 5E). A step 556 looks to see if the message contains “@halibot.com”, for example. Iterations are made through each address in the “To:” header while searching for a single address ending with “@halibot.com”. Such designates a topic a user is querying, e.g., “weather@halibot.com”. If the address currently being examined ends with “@halibot.com” (e.g. the local domain name) in case-insensitive comparison, it is considered a “local” address. A step 558 sees if a local address has already been seen while iterating through the “To:” addresses. At this point, an address has been found in the list of “To:” addresses that ends in “@halibot.com”. Only one topic per request is allowed. A variable “ourEmail” is stored to designate the local topic e-mail address that is being invoked. If this variable has already been set and another local address is found in the “To:” header, there are more than one local addresses. Such triggers an error condition in a step 560. If the “ourEmail” variable has not yet been set (it's null), this local address is the first one seen, and a step 562 sets “ourEmail” to this address, and iterating continues. A step 564 adds this e-mail address to the list of additional recipients if the address in question doesn't contain “@halibot.com” (it is not considered a local address). It is simply added to a list of additional recipients who will ultimately be copied on the response. A step 566 looks for more addresses. Once iterating through the “To:” header's e-mail addresses is complete, a step 568 looks to see that there is one and only one local address, e.g., ending in “@halibot.com”, to signify the topic being queried. If the “ourEmail” variable has not been set (it's null), there is no way of determining which topic is being queried, and so a step 570 is an exit for the error condition. A step 571 strips any leading and trailing whitespace from “ourEmail” and checks for a “Reply-To:” header, in order to keep track of who sent this e-mail message. The sender's e-mail address is stored in the “senderEmail” variable in a step 572. If there exists a “Reply-To:” header, “senderEmail” is set to the value of that header. If not, “senderEmail” is set to the value of the “From:” header which may not be defined. If “senderEmail” is null in a step 573, there no way of determining the sender's e-mail address. This is an error condition, and exits at a step 574. A step 575 sees if the senderEmail begins with “mailer-daemon@”. If the “senderEmail” variable starts with “mailer-daemon@”, consider the message to be a “bounce” message, not a legitimate, normal message. If this is the case, the message is ignored in a step 576. A step 577 separates the “Cc:” header into a list of addresses. The same process is used to separate addresses that may be specified in the “Cc:” header. It is important to verify that each e-mail address is valid to avoid a bounce back. Valid e-mail addresses will pass the following tests,

It must contain an ‘@’ character
The ‘@’ must not be the first or last character in the string
A ‘.’ character must not immediately precede or follow the ‘@’
The last ‘.’ character must come after the ‘@’
The ‘.’ must not be the last character in the string
The string must not contain any spaces

In a step 578 the “genreName” is parsed. In order to determine the genre or “topic”, the “ourEmail” variable is examined and truncated up to but not including the “@′” character. For example, in the case of “weather@halibot.com”, “genreName” is set to “weather”. Then a check is made to see if there is an entry in the “genre” database table, in order to validate the topic that the user is querying. An active entry in the “genre” database table with a name matching the “genreName” is parsed out of the e-mail address, e.g., using “weather”, “select id from genre where upper(name)=upper(‘weather’) and is_active=‘Y’”. If this query returns a valid genre, the id is stored in the “genreld” variable. A step 579 looks to see if the sender has a shortcut with that name. It's possible that the user is invoking a “shortcut” if a matching active topic is not found in the database. This step can check to see if the sender has a shortcut with the same name (using “dan@checkoway.com” as an example for “senderEmail” and “mywx@halibot.com” as an example for “ourEmail”),

select shortcut.id from e-mail,shortcut where
upper(email.email)=upper(‘dan@checkoway.com’) and
shortcut.account_id=email.account_id
and upper(shortcut.name)=upper(‘mywx’)

If this query returns a valid shortcut, it is stored in the ID in the “shortcut” variable. If there are genre alias with that name, or a matching active topic or shortcut was not found in the database, it's possible that the user is invoking a topic by using one of many aliases possible. For example, the “airfare” topic has fares, lowfare, lowfares. In the following SQL statement, “lowfare@halibot.com” is used to illustrate this point,

“select genre.id from genre_alias, genre where
upper(genre_alias.alias)=upper=(‘lowfare’) and
genre.id=genre_alias.genre_id and
genre.is_active=‘Y’.”

If this query returns a valid genre, it is stored the ID in the “genreld” variable. The system now knows what topic the user is querying.

A step 581 sees if the first line of the message body begins with “Subject:”. Some devices do not support the ability for users to specify the subject of an outgoing e-mail address. For example, some cell phones will hard-code the subject of all outgoing messages to something like “MESSAGE FROM MOBILE”. This would ordinarily preclude users of these devices from being able to use our system. To compensate, users are allowed to “override” the subject in the body of the message by making sure the first line in the body starts with “Subject:”. For example, if this were the first line in the message body, “Subject: Newport Beach, Calif.”, everything following “Subject:” is taken and overrides the “Subject:” header with this value. A step 582 gets the needed parameters from the message body. A step 583 gets them from the subject header. A step 584 removes any “Re:” from the parameters. Typically, when e-mail client applications compose replies to messages, “Re:” is prepended to the subject of the reply message. For example, if a user replied to a prior response, the subject of their new message sent to us might be, “Subject: Re: Newport Beach, Calif.”. In order to compensate for this, all instances of “Re:” are removed from the subject. A step 585 removes regular expression from parameters. Some e-mail client applications keep track of how many times a message has been replied to, and they include a numerical counter in the reply “prefix”. For example, on the second reply to a given message, the subject may be “Subject: re[2]: Newport Beach, Calif.”. The “2” doesn't appear every time, and on the third reply it would be “3”, etc. To compensate for this, a regular expression is used to detect and strip out all instances of these numerically counted reply prefixes. The regular expression is “[Rr]e\[[0-9]*\]:”.

A check is made to see if there is an “X-Mailer:” header. In order to best serve the user, the system provides as robust a response as possible. If the e-mail client application they are using supports HTML, the system will send an HTML response. If the client application they use doesn't support HTML, the system will send plain text. Most e-mail clients identify themselves within the headers of every e-mail message they compose. This is done by use of the “X-Mailer:” header. If this header is seen, the identified e-mail client is remembered.

A check is made to see if there is a “User-Agent:” header. Some e-mail client applications are non-standard and do not conform to the rules about the “X-Mailer:” header. Some of them make use of the “User-Agent:” header instead. If the “X-Mailer:” header is missing, the system looks for the “User-Agent:” header and interpret it in exactly the same manner.

A step 586 sees if the parameters contain format keywords. Typically, the most appropriate format of the response is automatically chosen based on the known capabilities of the identified e-mail client application. Sometimes, however, a user may want the ability to override this feature. For example, if the user wants text results where they would ordinarily be delivered in HTML, a mechanism for controlling that behavior must be provided. This is accomplished through use of “format keywords”. In the subject of the message, users can embed keywords to control format, e.g., [text], [html], [wml], [raw], etc. A step 587 loads format from the e-mail table in the database. If any explicit format keywords were not found, a check is made to see that the user prefers an “auto-detection” of the most appropriate format before that choice is made for them. The alternative would be for a user to have previously specified a fixed format that they always want to receive. This format is stored with each e-mail address in the database (the “format” column in the “e-mail” table). By default, the value is ‘A’ (auto-detect), but it can be ‘T’ (text), or ‘H’ (HTML). A step 588 constructs and executes an SQL insert string. In order to communicate to other back-end processes that there has been a request that needs to be processed, a row is inserted into the “mail_queue” database table. A typical insert SQL statement looks like this insert into mail_queue(id, created, priority, being_processed_by, began_processing, completed, sender_email, x_mailer, format, our_email, addl_recipients, genre_id, parameters, shortcut_id) values(null, now( ), 0, null, null, null, ‘dan@checkoway.com’, ‘Microsoft Outlook Express 5.00.2919.6600’, ‘A’, ‘weather@ halibot.com’, ‘copymy@friend.com’, 8, ‘Newport Beach, Calif.’, null).

FIG. 5E begins with a step 592 that gets an “embedded” e-mail address from a string. A step 594 strips it down to only what is contained between ‘<’ and ‘>’

When e-mail messages get sent, sometimes e-mail addresses get “resolved” by the mail server into people's real names, which get displayed right alongside the e-mail addresses “From: “Dan Checkoway” <dan@checkoway.com>”. The parsing for e-mail addresses looks for the “embedded” e-mail address. The string is stripped down to only that which lies between the ‘<’ and ‘>’ characters. A step 596 strips off any leading and trailing quotes. Sometimes, the e-mail address is bracketed between ‘<’ and ‘>’, The e-mail client application places either single or double quotes around the embedded address. These quotes are stripped off the ends of the e-mail address in a step 596 to establish the bare address. A step 598 returns the address.

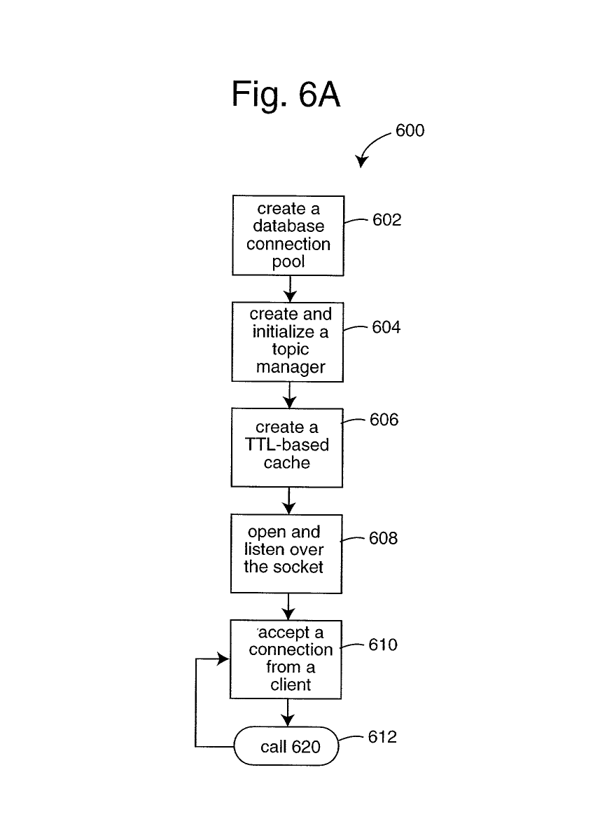

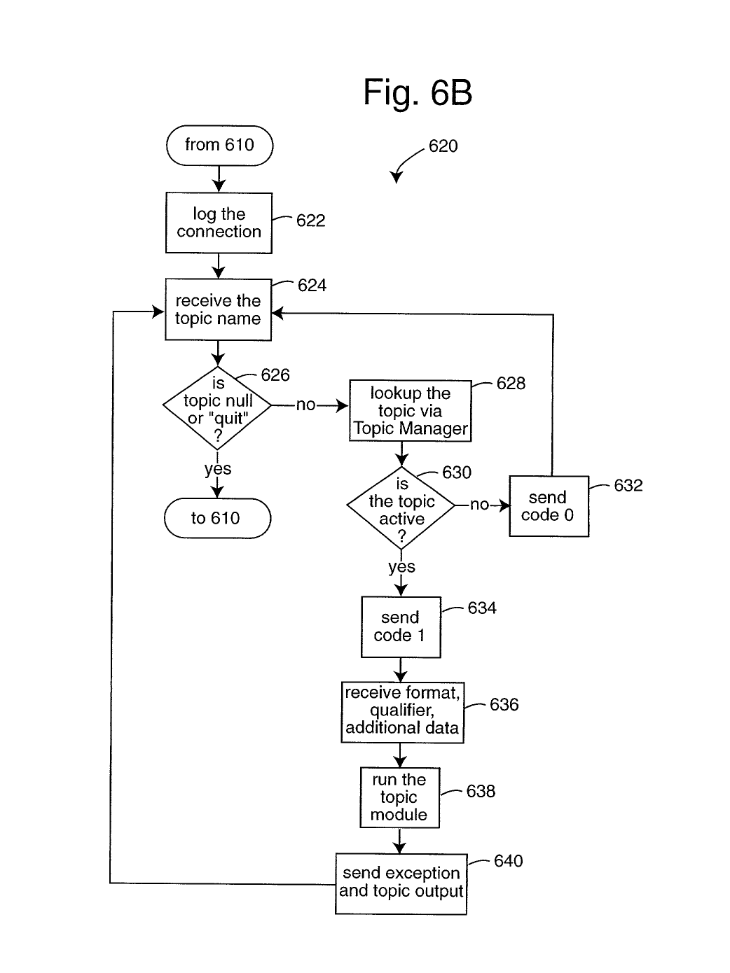

FIGS. 6A and 6B illustrate a topic server embodiment of the present invention. The topic server is a critical component of the system. Much of the code that actually implements the parsing of queries and the fetching, trimming, and formatting of data exists in a library of “topic modules”. Each topic module is created to serve one and only one topic. For example, separate topics are created to serve the weather and almanac topics. A topic is responsible for parsing input based on its particular qualifier syntax, producing or retrieving and filtering results based on the qualifier, and returning results in all supported output formats. Each topic module is typically implemented in Java or C++ programming code. A core library of several topic modules is used. Each of these class objects are derived from a virtual base class wherein active topics are tied to their respective implementations by a “module_classname” column in the “genre” table. For example, a “thesaurus” topic has “dcThesaurus” as its module name. A “dcThesaurus” is a C++ class object that resides in the topic library.

To illustrate specifically the way a topic is implemented, dcThesaurus.cpp is included here for reference (stripped down to the bare essence—the run( ) and getRawResults( ) methods—and simplified slightly for clarity):

void dcThesaurus::run(const dcCString &input,

ostream &out,
outputFormat fmt,
ostream &log)

throw (const dcError &)
{
log <<“deThesaurus module is running” <<endl;
dcCString response;
if (!getRawResults(input, response, fmt, pool,

additionalData, cache, out, log) ||

response.isNull()) {

return;

}
if (fmt == raw) {

out << response;
return;

}
else if (fmt == html) {

changeHTMLTargets(response);
out << response;
return;

}
response.strip();
response.foldSpaces();
response.replaceAll(“\n.”, “\n..”);
response.replaceAll(“:\t”, “:”);
response.removeAll(‘\n’);
response.replaceAll(“</tr>”, “\n”, dcCString::ignoreCase);
response.replaceAll(“<BR”, “\n<BR”, dcCString::ignoreCase);
response.replaceAll(“<sup>1</sup>”, “”, dcCString::ignoreCase);
dcCString body = stripHTMLTags(response);
body.strip();
body.foldSpaces();
body.replaceAll(“:”, “:”);
body.replaceAll(“\n”, “\n”);
out << body;
}
dcBoolean dcThesaurus::getRawResults(const dcCString &input,

dcCString &response,
ostream &log)

throw (const dcError &)
{
dcURL url(“http://www.m-w.com/cgi-bin/thesaurus?book=Thesaurus&va=” +

encode(input));

url.fetch();
url.getFullyQualifiedContent(response);
log <<“Translating response from server” <<endl;
if (!response.truncateLeftAt(“Entry Word”)) {

return FALSE;

}
response.truncateRightAt(“</form”, dcCString::ignoreCase);
return TRUE;
}

When a topic module is run, it first gets a “raw” result by fetching an HTML web page via HTTP from a known data source. The HTML is trimmed down to its bare essentials. Once these raw results are established, the topic module branches based on the requested output format, and either returns the raw results, HTML results (with minor modifications, such as fully qualifying all links), or text results. The latter case is the one that involves the most per-topic custom implementation. Each topic is responsible for stripping and/or parsing the raw HTML results and returning them in meaningful, well-laid-out text format Each topic module is uniquely adapted to its data source's particular style of HTML.

The data sources for topic modules are not limited in any way to HTML web pages fetched or posted to via HTTP. In many cases, the data sources are in-house, living within the same main database as user account information. Examples of these kinds of topics would be “zip code” and “area code”. No matter how the information is retrieved, each topic module abstracts away the methodology and acts as a black box that the topic server can make use of at any time without having any knowledge of where the information is coming from or how it gets processed. This is the true essence of topic server's design.

As the topic server handles requests, it needs to know how to properly dispatch a request for a particular topic. Correlation between a topic name and a topic module are made by a “topic manager” gateway between the topic server, the database, and each of the topic modules.

In FIG. 6A, a topic server 600 comprises a step 602 that creates a database connection pool to minimize the impact of needing to connect and disconnect from the database every time a query needs to be executed. So a pool of persistent database connections is preferably created. Such connection pool starts out with zero open connections to the database. As the database is needed by various threads running simultaneously, connections are opened and the pool grows in size. The maximum number of connections in the pool is fixed upon creation, based on a value specified in the configuration file. Typically the number of allowable database connections is half the number of threads the topic server uses to process requests. The connection pool is implemented in form of a C++ object that is passed to each topic module when it executes a query. Mutex locking prevents multiple threads from using the same database connection simultaneously. In fact, if the connection pool size was sixteen, and seventeen threads needed connections to the database, one thread would end up waiting until a connection was freed up.

When the topic server starts up, it creates a topic manager object. This loads all the relevant topic information from the database, and creates a topic module object for each active, implemented topic. Whenever the topic server needs to handle a request for a given topic (by name), it asks the topic manager for a handle to the respective topic module. The topic manager is initialized in a step 604 with an SQL statement, e.g., “select id, name, module_classname from genre where is_active=‘Y’ and module_classname is not null order by name”. For each row returned by this query, the topic manager creates a topic module object, with a name specified in a “module_classname” column. As topic manager creates these topic module objects, it simultaneously creates a “mapping” between them and topic names. This mapping can be used at any time to get a handle to the respective topic module object for a given topic name. While building the topic mapping, the topic manager also loads all “aliases” for each topic. An alias is another name that the topic can be called (for example, “driving” is an alias for “directions”). All aliases for a given topic are also mapped to the respective topic module objects.

A step 606 creates a time-to-live (TTL) based cache in order to boost performance. Topic modules can use it to temporarily store raw results and avoid re-issuing the information request. The time-to-live means that the entry lifetime is specified, and after being expired the data is flushed from the cache. Each topic module is responsible for making sure that time-sensitive data is cached for an appropriate amount of time. Data that is less sensitive can be cached for much longer periods. In general, an advantage of using such cache is the improved performance of repetitive or common queries. A repeated query can be processed nearly instantaneously by using cached data. A step 608 opens a socket and listens for client connections. There is a pool of server threads, each of which is constantly accepting a client connection over the socket. Whenever a connection is established in a step 610, the respective server thread processes the client's request(s) by a step 612 that calls a process 620 (FIG. 6B).

In FIG. 6B, a step 622 logs the connection by inserting an entry in a log file. This means that the client has connected and the session has begun. A step 624 receives the topic name. The client sends a string to indicate the name of the topic being queried. A step 626 checks to see if the topic is null. If not, a step 628 looks up the topic via a topic manager. A handle is established to a topic module object associated with the given named topic. A step 630 checks to see if the topic is active. If not, a code-0 response is returned by a step 632. If active, a step 634 sends a code-1 response. A step 636 receives format, qualifier, and other data from the client. Two length-prefixed strings are sent over the socket, the requested output format and the topic qualifier. After that, an “additionalData” hash is sent, e.g., first the number of entries, then each length-prefixed key and value. A step 638 runs the topic module. All the information needed to run the query is on hand. The topic module object's run( ) method is called with all relevant parameters. A step 640 sends any exception and the topic output to the client.

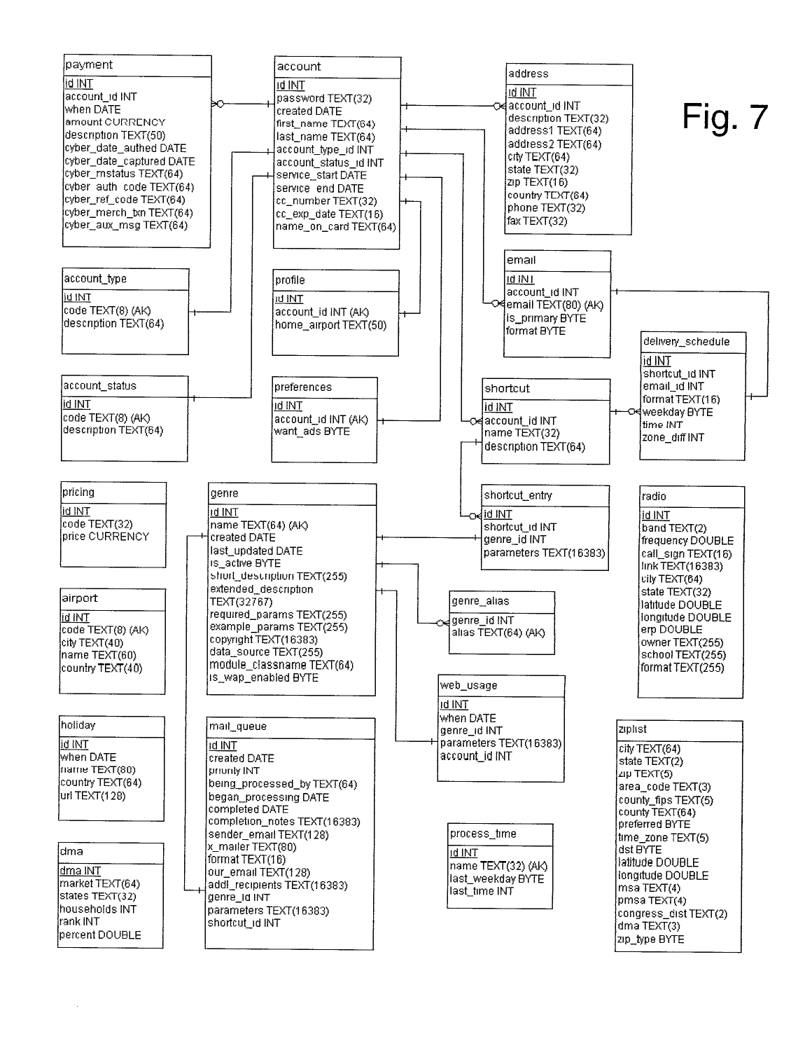

FIG. 7 represents one way to organize databases 112 and 212. Such databases typically include a “mail queue” table. Whenever an e-mail query is received by receiver 110 and 210, an entry is stored in this table. The composers 116 and 218 pick up and handle requests that are pending. The following Table is typical of the mail_queue table's structure.

mail_queue

| Column Name | Description |
|---|---|
| id | Primary key, row identifier |
| created | Date/time when the request was created |
| priority | Numerical priority of the request, |
| | 0 is the highest priority |
| being_processed_by | Name of the process that is handling the request |
| began_processing | Date/time when the request was first |
| | picked up for handling |
| completed | Date/time when the request was finished being |
| | handled |
| completion_notes | Notes about any error conditions that |
| | occurred while handling |
| sender_email | E-mail address of the person making the request |
| x_mailer | E-mail client application identifier, e.g., |
| | “Microsoft Outlook Express...” |
| format | Requested output format, e.g., “html” or “text” |
| our_email | E-mail address to which the request was sent, |
| | e.g., “weather@halibot.com” |
| addl_recipients | Additional e-mail addresses that get copied |
| | on the response |
| genre_id | Id of the topic being queried |
| parameters | Query parameters |
| shortcut_id | Optional ID of a shortcut being invoked, |
| | instead of genre_ID/parameters |

Each request is queried against a given topic. Topics are defined in a “genre” table, e.g.,

genre

| Column Name | Description |
|---|---|
| Id | Primary key, row identifier |
| name | Name of the topic, e.g., “weather”, “golf” |
| created | Date/time when the topic was created |
| last_updated | Date/time when changes were last made |
| | to the topic |
| is_active | ‘Y’ or ‘N’ to indicate whether the topic is active |
| short_description | Brief one-line description |
| extended_description | Full description |
| required_params | Qualifier syntax, e.g., “BusinessName, Location” |
| example_params | Example of the qualifier syntax, e.g., |
| | “Shoe Repair, Newport Beach, CA” |
| copyright | Copyright/attribution for the topic's data source |
| data_source | Internal tracking of the topic data source |
| module_classname | Implementation's C++ class object name, |
| | e.g., “dcWeather” |
| is_wap_enabled | ‘Y’ or ‘N’ to indicate whether the topic |
| | is supported under WAP |

These two tables are sufficient for a minimal system that can do “anonymous” request processing. An extended system adds user identifiers. Each user has an “account” table that includes basic information, e.g., first and last name, account status, credit card number, and credit card expiration date. Each row in the “account” table preferably has a corresponding row in both the “profile” and “preferences” tables. Such “profile” table stores information that defines the user, user lifestyle and location. The “preference” table stores information about how the user prefers to be treated, e.g., whether the user wants advertisements included in responses. Each user also has one or more row in the “address” table, one for home, one for work, plus additional custom user-defined addresses. Each user may have entries in a “payment” table which records all user payment events. Trial, non-paying users, do not have payment entries. Registered users have at least one payment, the cost of the initial subscription.

Each user has at least one row in an “e-mail” table, and each row corresponds to a unique e-mail address that belongs to a given user. Such provides the link between a request and the registered user, “sender_email” in the “mail_queue” table will equal the user's e-mail address. With this link, the user's profile, preferences, and addresses are known so a personalized, meaningful response can be generated.

Users can also create shortcuts, which simplify the process of making common requests. Each shortcut stored in a “shortcut” table has one or more row in a “shortcut_entry” table. Each “shortcut_entry” represents a topic/qualifier pair. A “composite” shortcut has more than one “shortcut_entry”.

Users can preferably schedule automatic delivery of queries that are facilitated by a “delivery_schedule” table. Once a shortcut is created, it is tied to an e-mail address and a day/time to be delivered. The scheduler 114 and 216 uses the “delivery_schedule” table to determine requests that need to be delivered, and then insert the respective entries into the “mail_queue” table for processing.

Alternatively, more tables can be included that provide data for internally implemented topics, e.g., “radio” (a database of radio stations), “airport” (worldwide airport information), “ziplist” (zip codes), area codes, and associated latitude/longitude locations.

“Virtual GPS” and custom keyword addresses methods are preferably included that allow users to identify and change their geographic locations dynamically, e.g., so information about goods and services can be constrained to list only local providers. An exemplary custom keyword addresses method allows users to send an e-mail to address@halibot.com with a subject line, “HQ=15 Sunset Ave, Miami, Fla., 33133”. Two keyword addresses are reserved for “Home” and “Work”. This allows the user to subsequently enter “HQ” or any other custom keyword address a current location for when a location is required to provide information with geographic proximity.

The virtual GPS method allows a user to notify the system 100 and 200 via e-mail or the web about a current location. For example, the user sends e-mail to “iamhere@halibot.com” with the subject line containing a current zip code, city, state, full address, custom keyword address, etc. For example, “Subject: HQ” or “Subject: 94133” or “Subject: 723 Vallejo St, San Francisco, Calif. 94133”. Such user can then omit the location in later queries. In which case the system 100 and 200 preferably assumes that the user's location is the one last entered using the virtual GPS method. The user can use this method at any time to dynamically change the location treated by the system 100 and 200 as the “default location”. Functionality is provided to enable the user to retrieve or display the current “default location” via e-mail or the web.

An action/transaction method is preferably included that enables e-mail users to get additional information about a particular answer element provided by the system 100 and 200 in response to a query, to select an answer element and to “forward” it to a different “topic” for the purpose of conducting a new query, to initiate, invoke or conduct a transaction or other process. The system 100 and 200 typically appends a textual trigger entry mechanism to actionable answer elements. For example, a business name and address that has been delivered as a result of a previous query. Specific trigger entry mechanisms can be variable, and can include sequence numbers or sets of brackets associated with each answer element, e.g.,

| | |
|---|---|
| [] | Galletti Brothers Shoe Repair |
| | 427 Columbus Ave |
| | San Francisco, CA |
| | 415 982-2897 |
| | 0.0 miles |
| [] | USA Shoe Repair |
| | 586 Washington St |
| | San Francisco, CA |
| | 415 781-7715 |
| | 0.3 miles |

A user “forwards” e-mail containing the answer element to a new address that can provide additional information or other action/transaction. For example, if the user wishes to get driving directions from a current default address to one of the answer elements, the user can “Forward” the e-mail to directions@halibot.com, for example. Each user “selects” a desired answer element that is to be “acted upon” by activating a specific trigger entry mechanism. For example, the user can enter an “x” in the brackets of the answer element selected, as in the following,

| | |
|---|---|
| [] | Galletti Brothers Shoe Repair |
| | 427 Columbus Ave |
| | San Francisco, CA |
| | 415 982-2897 |
| | 0.0 miles |
| [x] | USA Shoe Repair |
| | 586 Washington St |
| | San Francisco, CA |
| | 415 781-7715 |
| | 0.3 miles |

The system 100 and 200 receives “forwarded” e-mail and appropriately identifies answer element selected. Based on forwarded address and various other factors, the system processes requests as required. The system 100 and 200 sends an appropriate response back to user, if required, which may include delivery of a new answer set, an additional request form requiring entry, or some other information.

The scheduler 114 and 216 is responsible for making sure all scheduled events get delivered on time, so there needs to be a backup in case of a failure. Such backup can be a simple storage mechanism in the database where a record of the last time the process was run is stored. In order to make this mechanism generic, there is a universal “process_time” database table that serves as the storage point for all time-sensitive applications. Thus, each application must uniquely identify itself when storing data in this table. The scheduler 114 and 216, when launched, is passed a “process name” in the command line parameters. Such value is stored and used for identification.

The scheduler 114 and 216 stores the “last process time” in the “process_time” database table. Included in this data are the weekday, a character representing a day of the week: “SMTWHFA” and the time of day, an integer whose hundreds are the hour and tens are the minute; e.g., 2205 means 10:05 pm. When the scheduler 114 and 216 first starts up, a look is made to see when processing was last done. This data is loaded from the table using an SQL statement, e.g., “select * from process_time where name=‘production1’”. The “last_weekday” and “last_time” attributes are loaded for keeping track of processing time.

Although the invention is preferably described herein with reference to the preferred embodiment, one skilled in the art will readily appreciate that other architectures may be substituted for those set forth herein without departing from the spirit and scope of the present invention. Accordingly, the invention should only be limited by the claims included below.

1. An information system accessible over a computer data network, comprising:
a user e-mail client able to send and receive e-mail messages;
an e-mail server able to send and receive e-mail messages;
a computer data network intermediate to the user e-mail client and the e-mail server;
a receiver for accepting e-mail messages over the computer data network;
a topic and a qualifier disposed in said e-mail messages that represent a reference information query;
a database for storing said topic and qualifier together with a return address of the user e-mail client;
a scheduler for invoking previously scheduled, stored requests;
a plurality of topic servers for researching information that can be used in said response, and that are selected according to said topic and filtered by said qualifier;
a composer for constructing a responsive e-mail message with information provided by one of the plurality of topic servers and that is sent to said return address.

2. The system of claim 1, further comprising:
an ad server connected to the composer and able to inject advertisements for which a fee has been paid.

3. The system of claim 1, wherein:
each one of the plurality of topic servers is specialized and researches a single topic area.

4. The system of claim 1, further comprising:
a webserver connected to the plurality of topic servers and the database, and having a HTTP connection to the Internet;
wherein, said topics and qualifiers can be delivered over the internet from a client browser, and said responses are composed as HTTP documents.

5. The system of claim 1, further comprising:
a webserver connected to the plurality of topic servers and the database, and having a HTTP connection to the Internet;
wherein, said topics and qualifiers can be delivered over the internet from a wireless client using WAP, and said responses are composed as HTTP documents that are delivered back to a respective wireless device.

6. The system of claim 1, wherein:
the composer selectively responses with either a plain text answer or an HTTP document that includes clickable hypertext that links to further information on said topic that can be browsed by a user.

7. The system of claim 1, wherein:
said qualifier is remembered for each said user and is used as a default qualifier when a current query lacks a qualifier.

8. The system of claim 1, wherein:
said qualifier represents a physical location of said user and responses to said topic are filtered according such physical location.

9. An electronic query method for a network client, comprising:
entering a topic in the form of “topic@recipient.com” into a send-to address line of an e-mail question message;
entering a qualifier on a subject line of said e-mail question message that constrains said topic or entering a qualifier preceded by “Subject:” in the message body of said email question that constrains said topic;;
sending said e-mail question message via a mail server on the Internet to a recipient corresponding to one referenced in said “topic@recipient.com”; and
receiving an e-mail answer message with a message body from said recipient that includes an answer to a database query which assumed a question about said topic was asked and said qualifier is to be used as a constraint.

10. An answering agent, comprising:
a plurality of incoming e-mail queries each with a “To:” field, a subject field, and a message body field;
a SMTP-server providing for receipt of said plurality of incoming e-mail queries;
a plurality of POP-mailboxes each corresponding to a topic that can be referred to in said “To:” field of a particular one of the plurality of incoming e-mail queries;
an answering-agent receiver that strips a topic and a qualifier from said plurality of incoming e-mail queries;
an answering-agent database for storing topics, qualifiers, and return addresses provided by the receiver;
an answering-agent scheduler for selecting a query in the database for response;
an answering-agent composer providing for an answer to said selected query to be generated within a message body field of a response;
a plurality of topic servers each responsive to a different query topic;
a plurality of outgoing e-mail answers that each include said answer in said message body field that corresponds to a respective one of the plurality of incoming e-mail queries; and
an action/transaction method providing a mechanism whereby email messages containing answers from one answering-agent can be replied-to or forwarded to another answering-agent to obtain additional information or to invoke other processes.

11. The answering agent of claim 10, further comprising:
an advertisement server connected to insert an advertisement in each of said outgoing e-mail answers.

12. The answering agent of claim 10, further comprising:
an advertisement server connected to not insert an advertisement in a particular one of said outgoing e-mail answers if it is addressed to a user who has paid a subscription fee.
